(19) United States
(12) Patent Application Publication
(10) Pub. No.: US 2020/0260670 A1
(43) Pub. Date: Aug. 20, 2020

(54) Scalable Aquaculture and Hydroponic (Aquaponics) Production Systems

(71) Applicant: Shiloka Kachabe, Troy, VA (US)

(72) Inventor: Shiloka Kachabe, Troy, VA (US)

(21) Appl. No.: 16/573,392

(22) Filed: Sep. 17, 2019

Related U.S. Application Data
(60) Provisional application No. 62/733,904, filed on Sep. 20, 2018.

(51) Int. Cl. A01G 31/02; A01K 63/04

(52) U.S. Cl. CPC A01G 31/02; A01K 63/042; A01K 61/10; A01K 63/045; A01K 63/047

(57) ABSTRACT

An aquaponics system utilizing_portable hydroponic growing apparatus suspended over an aquatic holding vessel. The vessel is filled with water and stocked with aquatic organisms. A pump of sufficient lift connects to plumbing which runs over the top of the portable hydroponic apparatus. The hydroponics apparatus are suspended directly over the water vessel in such a way that the water drips back into the holding vessel below. Drip rate control emitters maybe installed to regulate the flow of water from the pump. This embodiment works well for low to medium intensity production. For higher intensity production, dedicated filtration and aeration devices are added.

### REFERENCES

U.S. Pat. No. 8,327,582 B2 * 12/12 Storey 47/62R

US20160113222A1—US Patent Application Masaharu Hori, Mitsuhiro Hotta

US14718545 US Patent Pending May 21, 2015

U.S. Pat. No. 9,439,403 B2 * 09/16 Alshammary

U.S. Pat. No. 8,677,942 B2 * 03/14 Bodlovich, Gleeson

1,425,4446 Pending Higgins

### FIELD OF INVENTION

This method pertains to a combination of aquaculture and hydroponics. This is also known as aquaponics. This invention relates to production of aquatic produce and plant crops in compact systems where land, labor and energy needs are reduced. Use of the vertical space above the aquatic holding vessel reduces space, plumbing, energy and labor requirements by keeping everything within a smaller space.

### BACKGROUND INFORMATION

Aquaponics, a combination of aquaculture and hydroponics, is a symbiotic relationship between plant and aquatic life. Aquatic life produces nitrogenous waste from biological processes and decomposition of uneaten food and other detritus in the water. If untreated, the water becomes toxic to aquatic life leading to stunted growth, disease and death.

On the other hand, plants need nitrogen to grow. In hydroponics, plants grow without soil, relying instead on mostly nitrogenous nutrients in a solution to which the root system is exposed.

Aquaponics essentially transfers the nitrogen ladened water from the aquatic vessel to the hydroponics system. The hydroponic plants absorb the nitrogenous waste which in the process purifies the water for reuse in the aquatic vessel.

The current state of the art of large scale aquaponics generally maintains the hydroponic and aquaculture elements of an aquaponics system on a horizontal plane. As such, larger areas are needed to accommodate the aquaponics systems. In cases where the hydroponic and aquaculture elements are arranged vertically, the hydroponic elements are composed of heavy, fluidized grow-beds filled with hydroponic media like gravel, rock, perlite, etc. These hydroponic beds are usually heavy and not portable.

The invention in this application reduces the area required to house the aquaponics system by using the space above the aquatic vessel and employs portable hydroponic apparatus instead of heavy fluidized beds.

### SUMMARY OF INVENTION

This invention comprises the following:
1. A suitable support structure installed over the aquatic holding vessel. The support has holding devices (hooks, nails, screws, pegs, pins, dowels, cables etc.) installed at appropriate spacing to hold the portable hydroponic apparatus.
2. Portable hydroponic apparatus in the form of tubes of any cross sectional shape and cross sectional area.
3. An aquatic holding vessel of any shape and capacity.
4. A main water line of any diameter running from the aquatic vessel up and along the top of the support structure. The mainline has perforations along its length coinciding with the location of the holding devices which hold the hydroponic apparatus.
5. Optional driplines may be installed into the perforations along the main water line.
6. Optional drip emitter regulators may be installed along the length of the mainline or, when used, at the end of drip lines leading into the top of the hydroponic apparatus.
7. A water pump.

For higher intensity production systems, dedicated aeration and filtration devices may be added as follows:
8. Dedicated filtration devices.
9. Dedicated aeration devices.

How it Works

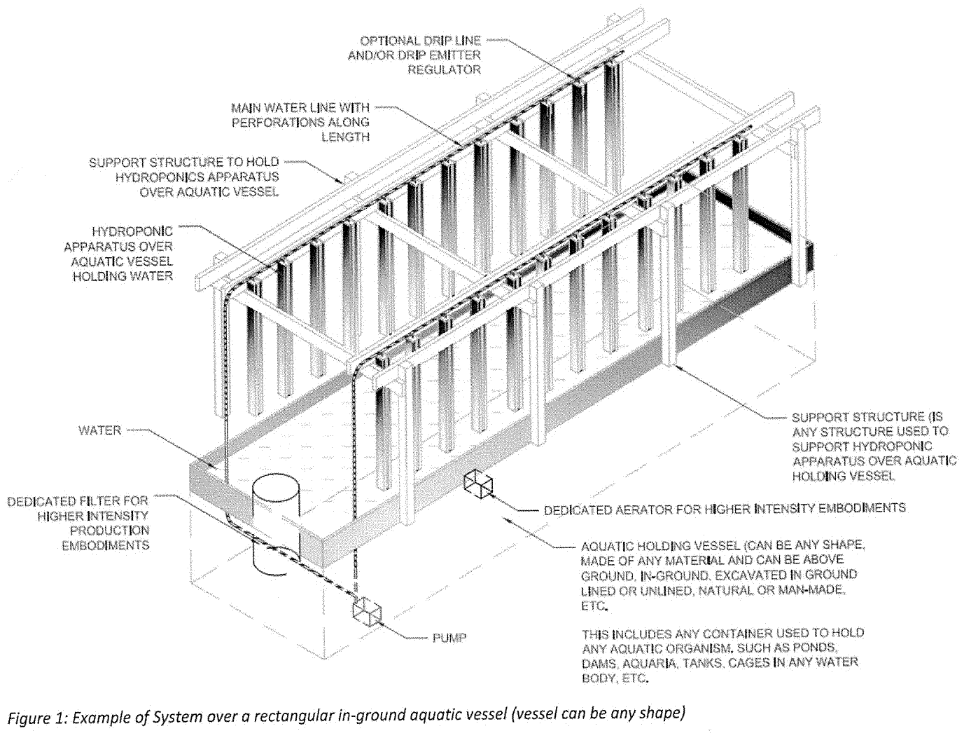

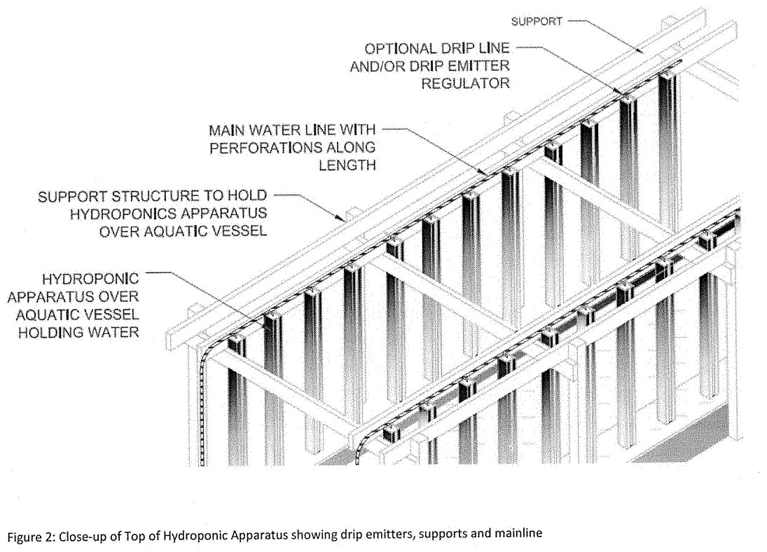

This system of production relies on gravity and pumps to work. With the items listed above assembled as shown in the embodiment depicted in FIGS. 1 and 2, water is pumped from the aquatic vessel below through the mainline running over the top of the hydroponic apparatus. The water comes out at the holes made in the mainline either directly into the hydroponic apparatus or through the smaller drip tubes into the hydroponic apparatus. Drip regulators may be used at none, some or all of the holes made in the mainline. Similarly, drip regulators may be installed at the end of the smaller drip tubes. The water goes through the hydroponic apparatus by gravity back to into the aquatic vessel below them. This water cycle maybe continuous or intermittent.

### DETAILED DESCRIPTION OF INVENTION

This aquaponics growing system is assembled in such a way that the aquatic holding vessel is directly beneath the portable hydroponic apparatus. It is composed of three main systems. The support system, the circulation system and the aquatic vessel.

The Support System

The support system provides a structure to hold the hydroponics apparatus and the plumbing. In all embodiments, the support system is built in such ways that the hydroponic apparatus are directly over the aquatic vessel.

The Circulation Systems

The circulation systems is composed of a main water line, pump, optional drip tubes, optional drip emitters and portable hydroponic apparatus.

The main water line runs along the length of the support above the top of the hydroponic apparatus. The main water line has perforation at intervals coinciding with the mechanism holding the hydroponic apparatus in such a way that water can drop directly into the top of the hydroponic apparatus. Conversely smaller feed drip tubes can be connected to the main supply line to get the water to the top of the hydroponic apparatus. In that case, the perforations in the mainline need not be directly above the hydroponic apparatus. To ensure even distribution of water, drip regulators may be used at none, some or all of the holes made in the mainline. In a similar manner, drip regulators can be installed at the end of the drip tubes.

A pump is connected to one end of the main water line while the other end may be closed off using suitable means or may be left open to let water out and back into the vessel below if the pressure from the pump is greater than needed.

The Aquatic Vessel

The aquatic vessels is a body of water into which the aquatic organism is stocked. It can be man-made or sections of natural bodies where this system and method may be employed.

How it Functions

This system of aquatic production does several functions necessary in aquaculture:
1. Water Aeration: when the water leaves the hydroponic apparatus suspended over the vessel holding the aquatic organism, it breaks the surface tension and aerates the water. Each location of a hydroponic vessel is an aeration point. The number and locations of hydroponic apparatus may be varied to meet the aeration needs of the aquatic vessel.
2. Water Biological Filtration: When water enters the hydroponic apparatus, it is laden with plant nutrients mostly in forms of nitrogen (nitrates, nitrites, ammonia, etc.). The nutrients if left to accumulate make water toxic to most aquatic organism. As the water passes through the media inside the hydroponic apparatus, the plants absorb the nitrogenous nutrients, hence purifying the water.
3. Suspended Solid Filtration: At the same time the water passes through the hydroponic apparatus, solid waste suspend in the water is trapped by the media inside the apparatus.

This low to medium intensity production embodiment allows practical cost efficiencies which are not enjoyed in traditional aquaponics. By arranging the hydroponic apparatus over the holding vessel the following efficiencies are realized:
1. Lowers plumbing needs. The plumbing is confined to the main water distribution line, drip lines and drip regulator emitters.
2. Allows use of smaller pumps. Because the plumbing lines are shorter due to close proximity to the pump, smaller sized pumps may be used. This translates in lower pump acquisition and running costs.
3. Eliminates dedicated aeration equipment for low to medium intensity production embodiments. Since water dripping back from the hydroponic apparatus provides aeration at each point it breaks the surface of the water in the aquatic vessel, it allows for adequate aeration of the water. The number of hydroponic apparatus can be varied to meet the aeration needs of the aquatic vessel. This removes the cost of acquiring and running dedicated aeration equipment. The pump plays the triple roles of irrigator, water circulator and aerator.
4. Eliminates dedicated filtration equipment for low to medium intensity production embodiments. The media inside the hydroponic apparatus traps the solids in the water, provides large surfaces for biological filtrations while the plants remove the nitrogenous waste from the water.

For higher intensity production embodiments, additional hydroponic apparatus may be added over the vessel. However, due to possible limitations to the number of apparatus that can be added to the support structure, dedicated aeration and filtration devices may be added. The aeration devices include but are not limited to: floating surface aerators, air compressors and/or blowers connected to diffusers submerged in the water vessel etc. Additional filtration devices that can be added include drum filters, Vortex filters etc.

The current state of the art of large scale aquaponics generally maintains the hydroponic and aquaculture elements of an aquaponics system on a horizontal plane. As such, larger areas are needed to accommodate the aquaponics systems. In cases where the hydroponic and aquaculture elements are arranged vertically, the hydroponic elements are composed of heavy, fluidized beds filled with hydroponic media like gravel, rock, perlite, etc. These hydroponic beds tend to be heavy and difficult to move.

The invention in this application reduces the area required to house the aquaponics system by using the space above the aquatic vessel and employs portable hydroponic apparatus instead of heavy fluidized beds.

The overriding benefit is the versatility this system offers in terms of scaling from small to commercial capacity and the relative lower costs associated with it. The details of these benefits follow:
1. Systems can be installed virtually anywhere with a reasonable water and energy supply. Sizes of systems can vary drastically from small household sizes holding a few pounds to massive commercial systems holding tens of thousands of pounds of aquatic organisms like fish, shell fish etc. The system is also easy to replicate.
2. This method of growing allows flexibility to accommodate on-the-ground needs. Aeration and filtration needs of the aquatic vessel are adjustable by adding or removing the portable hydroponic apparatus. They can also be varied depending on how much vegetative produce is desired. In addition, the hydroponic apparatus can also be arranged to suit the shape of the holding vessel with ease. Holding vessels tend to be inflexible.
3. By utilizing the space above the aquatic vessel, this method of aquaponics uses a much smaller foot print. Where the system is housed in one, this compactness allows the use of smaller greenhouses, which leads to lower construction and running costs.
4. The compactness of the systems make them more cost efficient than traditional aquaponics. The saving come from the following:
   i. Lower initial investments coming from smaller greenhouses where they are used.
   ii. Lower initial investments due to elimination of dedicated aeration equipment usually needed in aquaculture. This is for low to medium intensity production embodiments.
   iii. Fewer plumbing needs and smaller pump sizes due to compactness of the system.
   iv. Lower running costs due to lower energy needs of the smaller pumps used and lower heating costs due to the smaller space requiring heat.
   v. Lower labor costs due to smaller spaces to maintain and cover.
   vi. Higher production per square foot due to utilization of the vertical space above the aquatic holding vessel.
5. This system of aquaponics renders itself to automation. Web enabled water and hydroponic monitors as well as automatic feeders can easily be installed. This lowers operating costs by reducing the need for labor.
6. These systems can be installed in areas were zoning restrictions may not allow larger scale agricultural activity. Dues to the compactness and the ease of replication, groups of systems can be built in most areas without offending most zoning regulators. For example, systems can be built in backyards as part of gardens without offending zoning regulators.

1. An aquaponics and hydroponics system for growing aquatic organisms and plants in compact spaces; the system comprising: A suitable support structure installed over an aquatic holding vessel, the support structure having holding devices (hooks, nails, screws, pegs, pins, dowels, cables etc.) installed at appropriate spacing to hold portable hydroponic apparatus; portable hydroponic apparatus in the form of tubes of any cross sectional shape and cross sectional area; an aquatic holding vessel of any shape and capacity; a main water line of any diameter running from the aquatic vessel up and along the top of the support structure, with the mainline having perforations along its length coinciding with the location of the holding devices which hold the hydroponic apparatus; optional driplines installed into the perforations along the main water line; optional drip emitter regulators installed along the length of the mainline or, when used, at the end of drip lines leading into the top of the hydroponic apparatus; a water pump; dedicated aeration and filtration devices for higher intensity production systems

2. The apparatus of claim 1 wherein the support system provides a structure to hold the hydroponics apparatus and the plumbing, with the support system built in such ways that the hydroponic apparatus are directly over the aquatic vessel; wherein the circulation systems is composed of a main water line, pump, optional drip tubes, optional drip emitters and portable hydroponic apparatus; wherein the main water line runs along the length of the support above the top of the hydroponic apparatus; wherein the main water line has a plurality of perforations at intervals coinciding with the mechanism holding the hydroponic apparatus in such a way that water can drop directly into the top of the hydroponic apparatus; alternatively smaller feed drip tubes connected to the main supply line get the water to the top of the hydroponic apparatus, in which case, the perforations in the mainline need not be directly above the hydroponic apparatus, and to ensure even distribution of water, drip regulators may be used at none, some or all of the holes made in the mainline; similarly, drip regulators can be installed at the end of drip tubes; a pump connected to one end of the main water line while the other end is closed off using suitable means or left open to let water out and back into the vessel below if the capacity of the pump is greater than needed; wherein the aquatic vessels is a body of water into which the aquatic organism is stocked, wherein the aquatic vessel is man-made or natural bodies; wherein for higher intensity production systems, dedicated aeration and filtration devices are added.

3. A method of growing allowing flexibility to accommodate on-the-ground needs wherein aeration and filtration needs of the aquatic vessel are adjustable by adding or removing the portable hydroponic apparatus and wherein hydroponic apparatus can also be arranged to suit the shape of the holding vessel with ease as holding vessels tend to be inflexible.
